(19) United States
(12) Patent Application Publication
(10) Pub. No.: US 2015/0040198 A1
(43) Pub. Date: Feb. 5, 2015

(54) SYSTEMS AND METHODS FOR ACCESSING A DEVICE USING A PAIRED DEVICE IN ITS PROXIMITY

(71) Applicants: Krishnanunni Gopalakrishnan, Ernakulam (IN); Francis Antony, Aluva (IN); Prasanth Padmalayam Thankappan, Aluva (IN); Manoj Venkatesh Rajamani, Ollur (IN); Aravindan Cheruvally, Guruvayoor (IN)

(72) Inventors: Krishnanunni Gopalakrishnan, Ernakulam (IN); Francis Antony, Aluva (IN); Prasanth Padmalayam Thankappan, Aluva (IN); Manoj Venkatesh Rajamani, Ollur (IN); Aravindan Cheruvally, Guruvayoor (IN)

(73) Assignee: Wipro Limited, Bangalore (IN)

(21) Appl. No.: 14/030,432

(22) Filed: Sep. 18, 2013

(30) Foreign Application Priority Data
Jul. 31, 2013 (IN) 3458/CHE/2013

(51) Int. Cl. H04L 29/06

(52) U.S. Cl. CPC H04L 63/08; H04L 63/102
USPC 726/5

(57) ABSTRACT

This disclosure relates to systems and methods for accessing a device using a paired device in its proximity. In one embodiment, a resource sharing method is disclosed, comprising: obtaining a proximal device identifier associated with a proximal device; identifying a proximal device profile associated with the proximal device identifier; retrieving access privilege data stored in the proximal device profile; generating, via a processor, user interface data based on the access privilege data; and providing the user interface data for display. The method may further comprise: providing, for the proximal device, an authentication key identifier and a request for user security input format data; obtaining, from the proximal device: an authentication key associated with the authentication key identifier, and user security input format data; determining that the proximal device is authenticated, based on the authentication key; and displaying a user security input interface based on the user security input format data.

### PRIORITY CLAIM

This disclosure claims priority under 35 U.S.C. §119 to: India Application No. 3458/CHE/2013, filed Jul. 31, 2013, and entitled “Systems and Methods for Accessing a Device Using a Paired Device in its Proximity.” The aforementioned application is incorporated herein by reference in its entirety.

### TECHNICAL FIELD

This disclosure relates generally to access control systems, and more particularly to systems and methods for accessing a device using a paired device in its proximity.

### BACKGROUND

Consumer devices provide the ability to set security patterns for controlling access to a device. These patterns often operate like numerical passwords and may be used for either authorizing access to the entire device or for providing condition- or level-based access to functionalities of the device.

Currently, for an owner's device to be made accessible to another user, the owner of the device must share the security pattern or device password of his/her device to the user. Such sharing of information may leave the device vulnerable to abuse or unwanted usage. Such usage could include accessing personal information stored in the device, using networking features, etc. With advancements in telecommunication systems, devices are increasingly used to provide functionalities for the user associated with sensitive information. Hence, access information or security codes of a communication device are highly confidential pieces of information that should not be shared or leaked.

### SUMMARY

In one embodiment, a resource sharing method is disclosed, comprising: obtaining a proximal device identifier associated with a proximal device; identifying a proximal device profile associated with the proximal device identifier; retrieving access privilege data stored in the proximal device profile; generating, via a processor, user interface data based on the access privilege data; and providing the user interface data for display. The method may further comprise: providing, for the proximal device, an authentication key identifier and a request for user security input format data; obtaining, from the proximal device: an authentication key associated with the authentication key identifier and user security input format data. The method may also include determining that the proximal device is authenticated, based on the authentication key, and displaying a user security input interface based on the user security input format data.

It is to be understood that both the foregoing general description and the following detailed description are exemplary and explanatory only and are not restrictive of the invention, as claimed.

### BRIEF DESCRIPTION OF THE DRAWINGS

The accompanying drawings, which are incorporated in and constitute a part of this disclosure, illustrate exemplary embodiments and, together with the description, serve to explain the disclosed principles.

FIGS. 1A-C illustrate an example of resource sharing device access using a proximal device, according to some embodiments of the present disclosure.

FIG. 2 is a flow diagram illustrating an example proximal device search procedure consistent with some embodiments of the present disclosure.

FIG. 3 is a flow diagram illustrating an example proximal device profile creation/updating procedure consistent with some embodiments of the present disclosure.

FIGS. 4A-D are flow diagrams illustrating an example resource sharing device access procedure consistent with some embodiments of the present disclosure.

FIG. 5 is a block diagram of an exemplary computer system for implementing embodiments consistent with the present disclosure.

### DETAILED DESCRIPTION

Exemplary embodiments are described with reference to the accompanying drawings. Wherever convenient, the same reference numbers are used throughout the drawings to refer to the same or like parts. While examples and features of disclosed principles are described herein, modifications, adaptations, and other implementations are possible without departing from the spirit and scope of the disclosed embodiments. It is intended that the following detailed description be considered as exemplary only, with the true scope and spirit being indicated by the following claims. For example, steps or processes disclosed herein are not limited to being performed in the order described, but may be performed in any order, and some steps may be omitted, consistent with the disclosed embodiments.

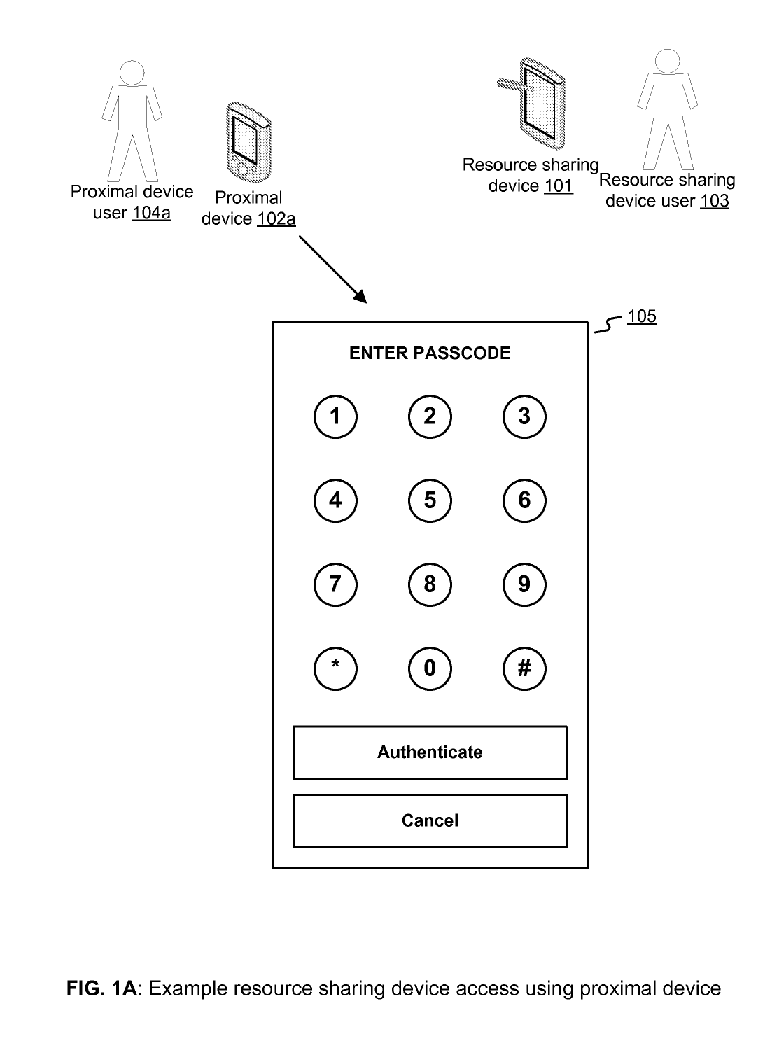

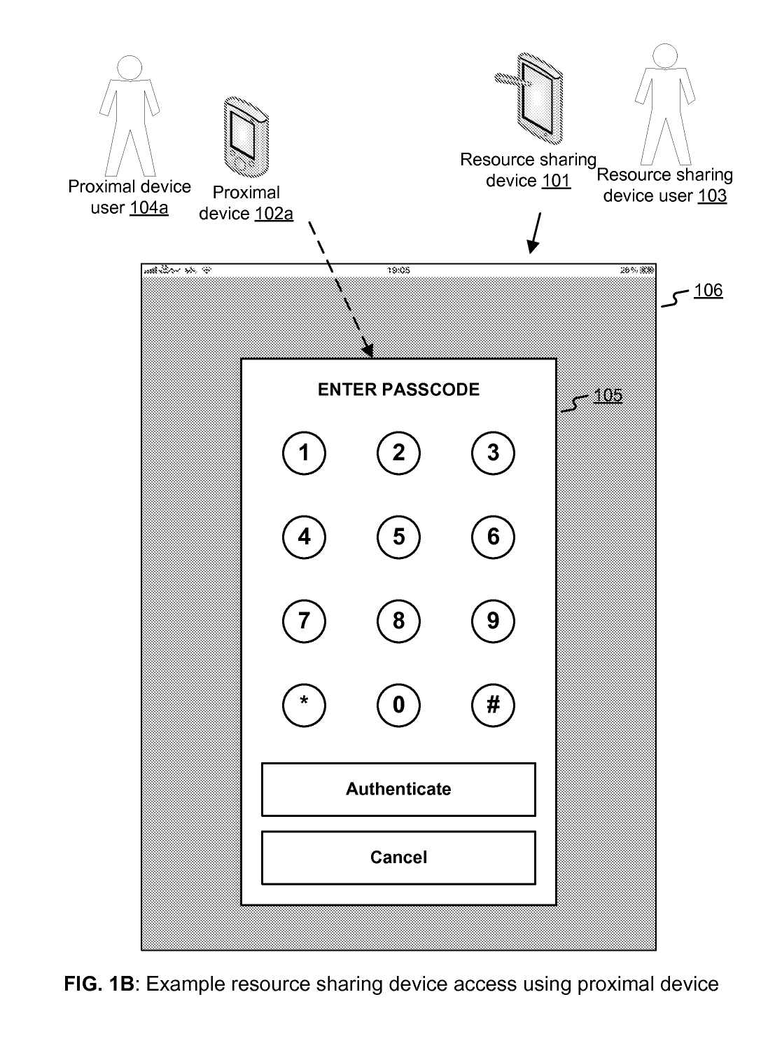

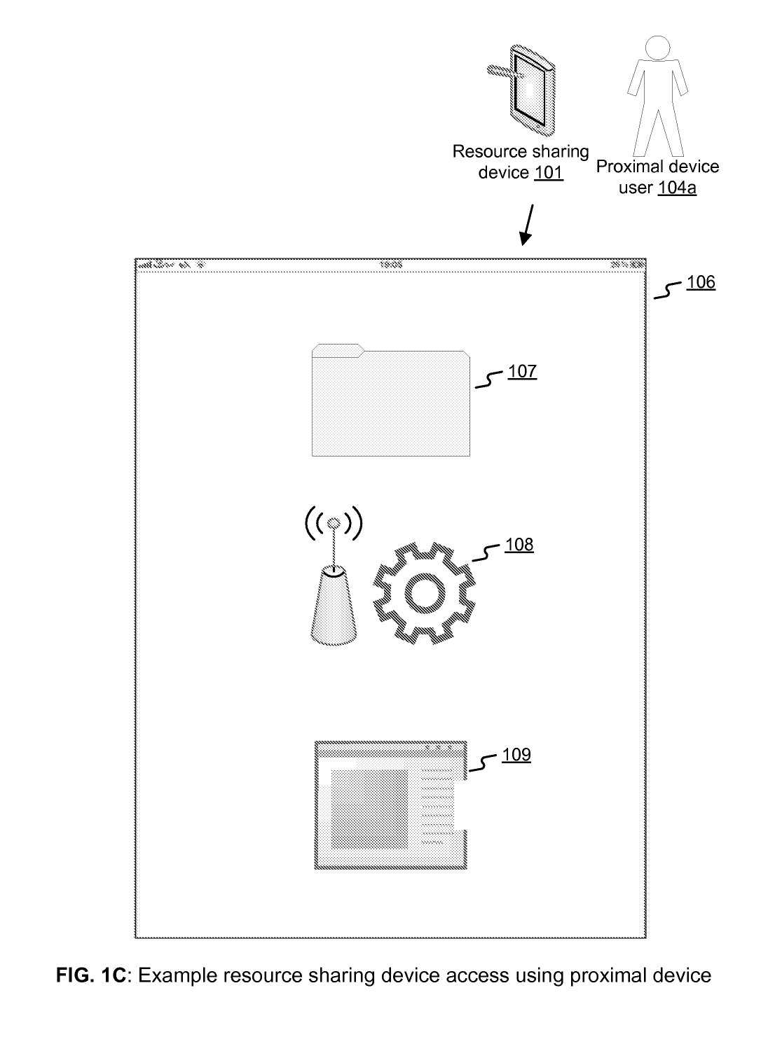

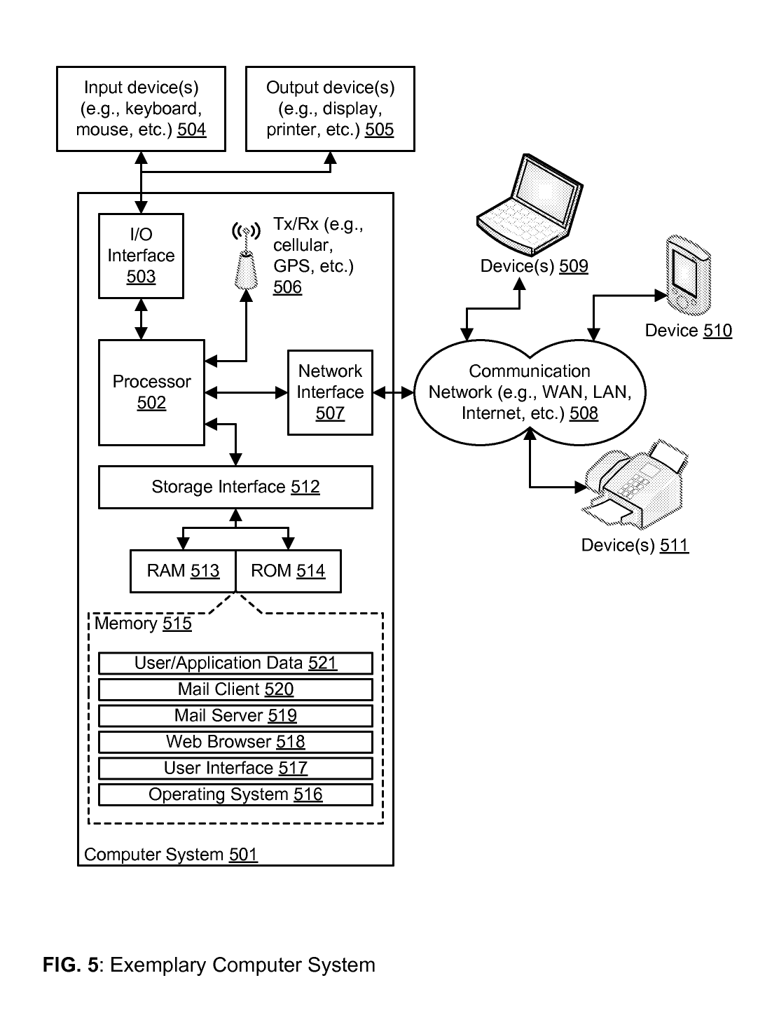

FIGS. 1A-C illustrate an example of resource sharing device access using a proximal device, according to some embodiments of the present disclosure. With reference to FIG. 1A, in some embodiments, a resource sharing device user 103 may desire to allow others, such as proximal device user 104a, to obtain limited access to resources, such as data, files, applications, use of hardware components (e.g., WiFi™ transceiver, USB ports, Ethernet ports, processor core(s), etc.), of a resource sharing device 101. Proximal device user 104a may have a proximal device 102a. Examples of devices that can serve as proximal device 102a and resource sharing device 101 are listed throughout the description with reference to FIG. 5. Also, the term “resources” includes, without limitation, any hardware or software, data, applications, utilities, modules, features, functions, components, devices within, attached to, or operably connected (e.g. using wireless communication such as WiFi™, Cellular, Bluetooth® etc. technologies) to a device such as resource sharing device 101 or proximal device 102a.

Proximal device user 104a may be able to unlock and utilize the resources of proximal device 102a by supplying a password or other authenticating input (e.g., finger swipe pattern, biometric identification, voice authentication, etc.) specific to proximal device 102a. For example, proximal device 102a may present a graphical user interface (UI)—a proximal device user security input UI 105—to the proximal device user 104a via an electronic display operably coupled to the proximal device 102a. The proximal device user may be able to input the password or other authenticating input using the proximal device user security input UI 105, to unlock the resources of the proximal device 102a.

With reference to FIG. 1B, in some embodiments, a resource sharing device user 103 desiring to allow the proximal device user 104a limited access to the resources of resource sharing device 101 may cause the resource sharing device 101 to create an access privilege profile on resource sharing device 101 for the proximal device 102a. The access privilege profile stored in memory on the resource sharing device 101 may include fields such as, without limitation, a profile name, an identifier of the proximal device 101 (e.g., a media access control (MAC) address, unique device identifier (UDID), Internet Protocol (IP) address, web browser fingerprint, etc.), a listing of resources of resource sharing device 101, access privilege data corresponding to the listing of resources, or the like. The resource sharing device 101 may accordingly have an access privilege profile database stored in internal memory or in one or more memory devices outside of but accessible to resource sharing device 101. Access privilege profile databases may be implemented in various embodiments as relational databases, object-oriented databases, structured data (e.g., XML or JSON-encoded text), tab-separated ASCII text, spreadsheet, Microsoft® Access databases, or the like. Table 1 below provides a non-limiting example of such an access privilege profile database.

TABLE I
Example Resource Sharing Device Access Privilege Profiles

| Name | Proximal Device ID | Proximal User ID | Privileges |
|---|---|---|---|
| Profile 1 | 01:23:45:67:89:ab | John.public | <f1, r>, <f2, rw>, <f3, rx>, <f4, rwx> |
| Profile 2 | 01:23:45:67:89:ab | Jane.doe | <f1, r>, <f5, rx>, <f6, r>, <f7, rwx> |
| Profile 3 | 99:88:77:66:55:zz | | <f1, r>, <f7, rx>, <f8, rx>, <f9, rwx> |
| Profile 4 | 192.168.1.101 | Proxy_user | <f1, r>, <f2, r>, <f5, rw>, <f6, rwx> |
| Profile 5 | 65.102.99.12 | | <f1, r>, <f5, rw>, <f7, rx>, <f8, rwx> |

Here, an entry <f1,r> may reference a resource <f1> of resource sharing device, and the access privilege profile may specify that the proximal user having proximal user ID “John.public” that is authenticated using a proximal device with proximal device ID “01:23:45:67:89:ab” may read (“r”) for the resource <f1>. Other examples of access privileges include, without limitation, write (“w”), read and/or write (“rw”), execute (“x”), and combinations thereof (e.g., read, write, and/or execute (“rwx”)). In some embodiments, a proximal device profile may apply to a specific set of proximal user IDs associated with a proximal device (e.g., “Profile1,” “Profile2,” and “Profile4” in Table I above). In alternate embodiments, a proximal device profile may apply to any proximal user IDs associated with the proximal device (e.g., “Profile3” and “Profile 5” in Table I above).

In some embodiments, the resource sharing device 101 may present a graphical user interface (UI)—such as resource sharing device UI 106—via an electronic display operably coupled to the resource sharing device 101. The resource sharing device 101 may communicate with the proximal device 102a, and request data from the proximal device 102a such that the resource sharing device 101 can, using the received data from proximal device 102a, recreate the proximal device user security input UI 105 of the proximal device 102a via the electronic display operably coupled to the resource sharing device 101. A proximal device user 104a can provide authentication input (e.g., password, finger swipe pattern, biometric identification, voice authentication, etc.) via the proximal device user security input UI 105 of the proximal device 102a, displayed on the electronic display of the resource sharing device 101, to obtain limited access to the resources of the resource sharing device 101. When the proximal device user 104a provides the authentication input, the resource sharing device 101 may communicate with the proximal device 102a, and provide to the proximal device 102a the authentication input provided into the resource sharing device 101 by the proximal device user 104a. Using the obtained authentication input, the proximal device 102a may determine whether the proximal device user 104a is authenticated, and may communicate the results of the authentication to the resource sharing device 101. With reference to FIG. 1C, if the proximal device 102a authenticated the proximal device user 104a, the resource sharing device may lookup its access privilege database to determine the access privileges to grant the proximal device user 104a as the proximal device user 104a utilizes the resources of the resource sharing device 101. For example, the resource sharing device 101 may present a resource sharing device UI 106, via which the proximal device user 104a may interact with the resource sharing device 101. The resource sharing device may grant access to files 107, hardware components 108, or software components 109, accessible via the resource sharing device 101. For example, such resources may be attached to or stored on resource sharing device 101, or they may be stored remotely (e.g., on a server) but be accessible to the resource sharing device 101.

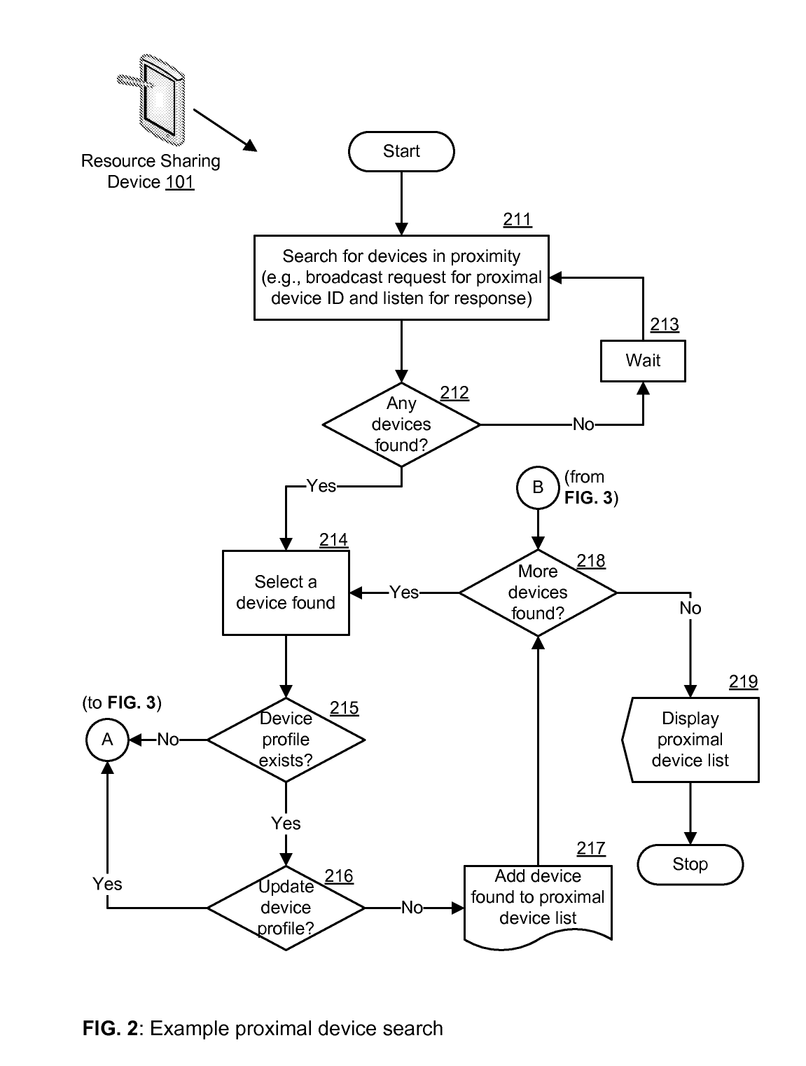

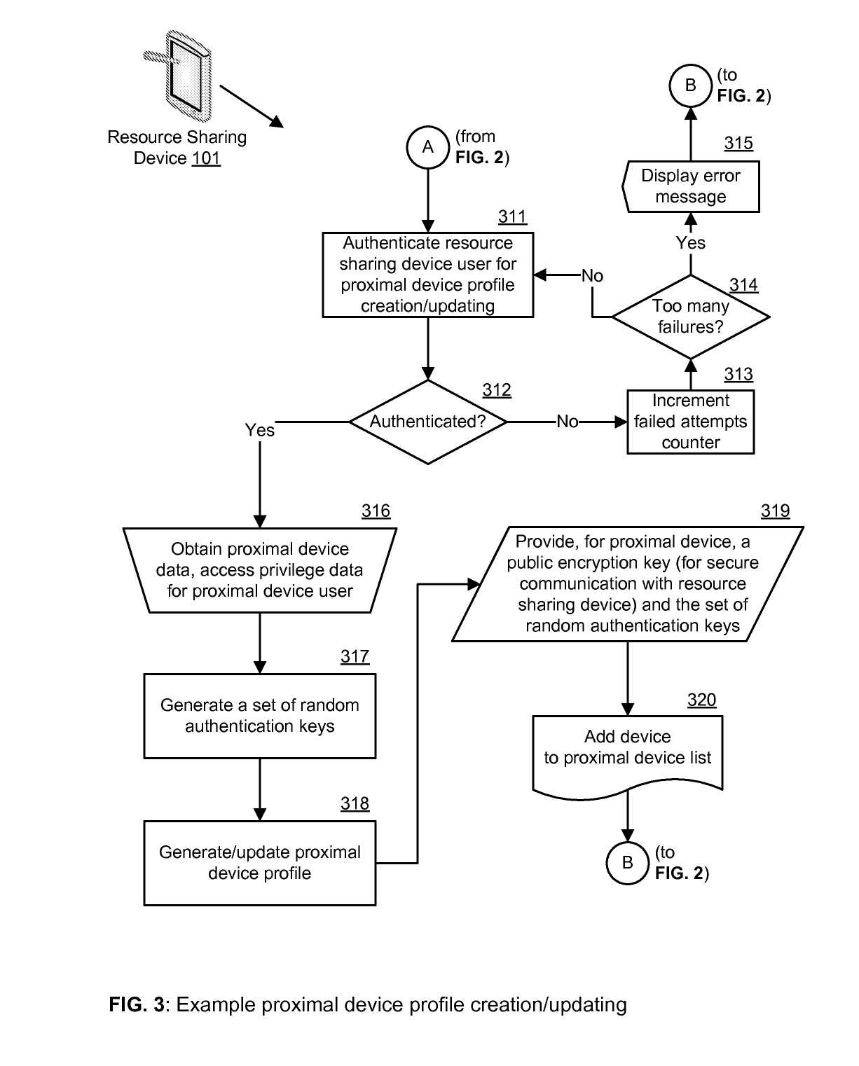

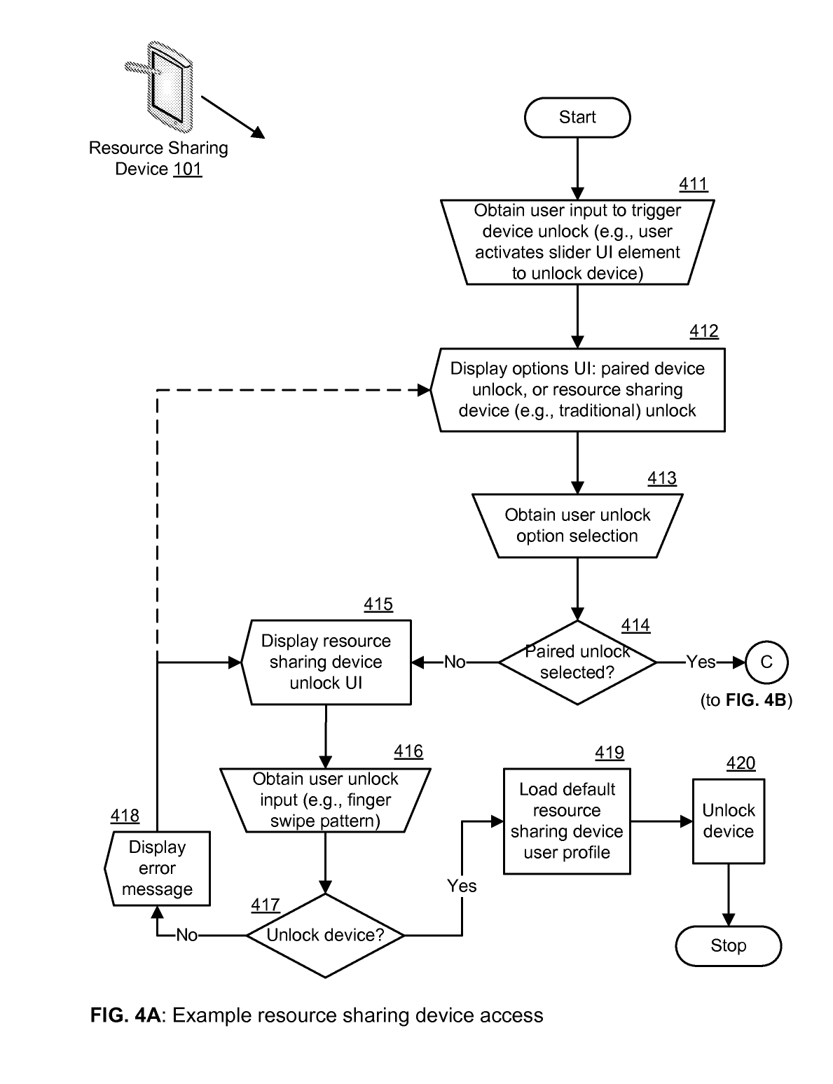

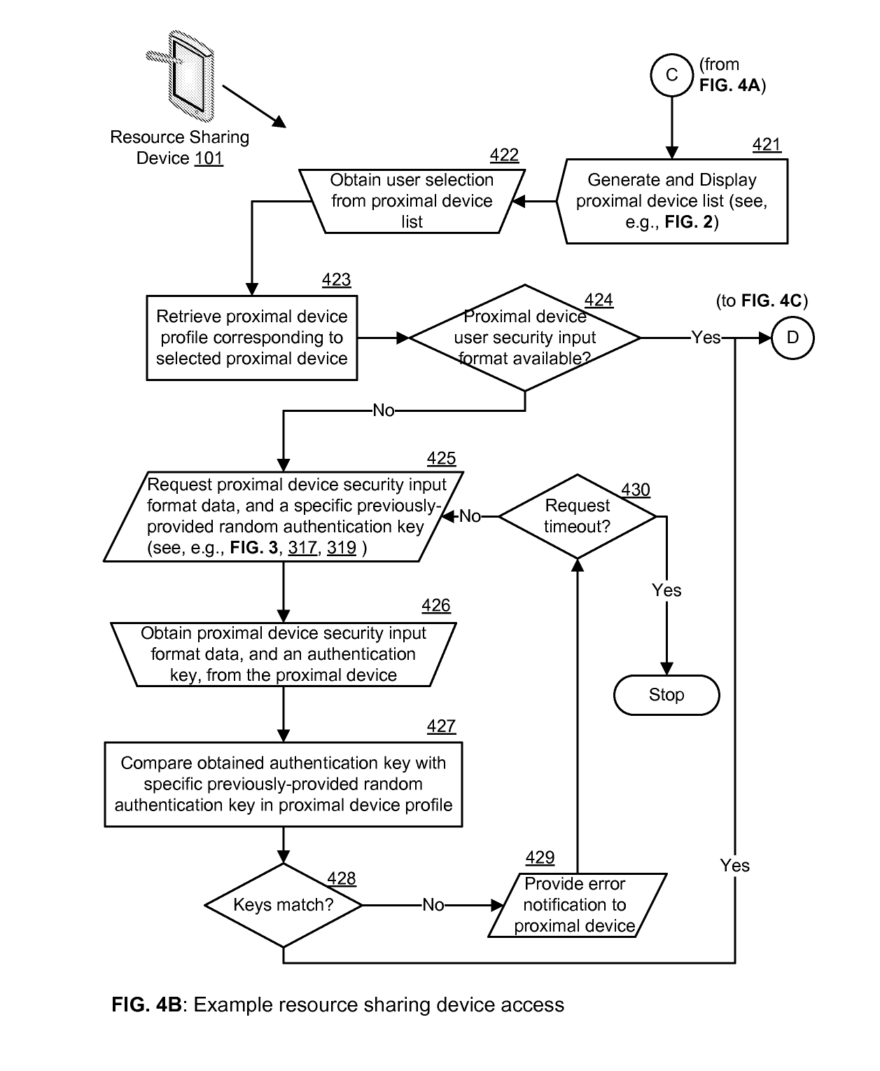

FIG. 2 is a flow diagram illustrating an example proximal device search procedure consistent with some embodiments of the present disclosure. In some embodiments, a resource sharing device 101 may search for devices in proximity to the resource sharing device (step 211). For example, the resource sharing device 101 may broadcast a request for proximal device IDs and listen for responses from proximal devices. The resource sharing device 101 may wait until at least one proximal device is found (step 213). If any proximal devices are found (step 212; YES), the resource sharing device 101 may select one of the found proximal devices (step 214) and lookup its access privilege profile database to determine whether an access privilege profile exists for the found proximal device (step 215). If no access privilege profile associated with the found proximal device exists (step 215; NO), or if the access privilege profile associated with the found proximal device requires updating (step 216; YES, the resource sharing device 101 may jump to a profile creation/updating process, an example of which is described further below in the description with reference to FIG. 3. Otherwise (step 216; YES), the resource sharing device 101 may add the found proximal device ID to a list of found proximal devices (step 217). If there are more found proximal devices (step 218; yes), the resource sharing device 101 may repeat the procedures 214-217 above. Otherwise, the resource sharing device 101 may display the found proximal device list via an electronic display operably coupled to the resource sharing device 101 (step 219).

FIG. 3 is a flow diagram illustrating an example proximal device profile creation/updating procedure consistent with some embodiments of the present disclosure. In some embodiments, no access privilege profile may be associated with a found proximal device, or an access privilege profile associated with a found proximal device may require updating. The resource sharing device 101 may, under such circumstances, implement a profile creation/updating process, an example of which is described further below. The resource sharing device 101 may begin by authenticating a resource sharing device user 103 to supervise the proximal device profile creation/updating procedure (step 311). If the resource sharing device user 103 is not authenticated (step 312; NO), the resource sharing device 101 may increment a failed attempt counter (step 313) and determine whether the number of authentication attempts exceeds a threshold (step 314). If so (step 314; YES), the resource sharing device 101 may display an error message via an electronic display operably coupled to the resource sharing device 101 (step 315) and the resource sharing device 101 may return to the procedure of processing other found proximal devices (see, e.g., FIG. 2, 218). If the number of authentication attempts does not yet exceed the threshold (step 314; NO), the resource sharing device 101 may allow the resource sharing device user 103 to re-attempt authentication (step 311).

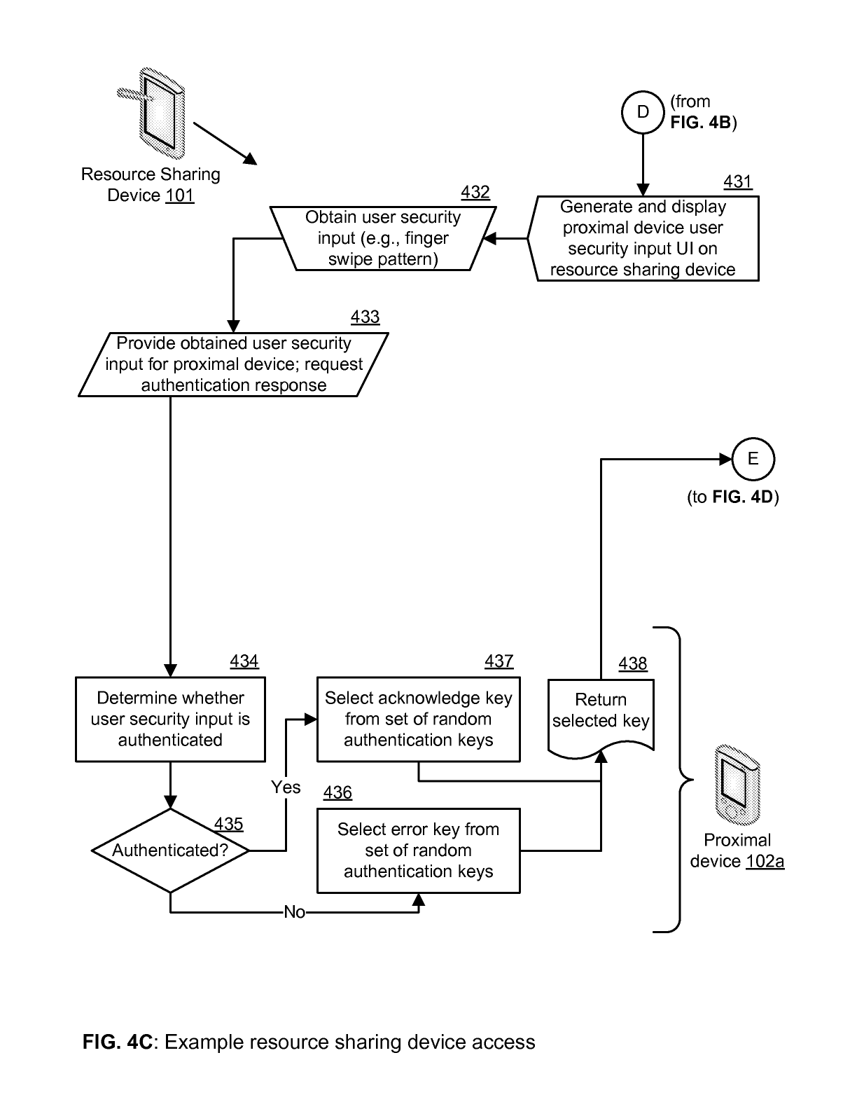

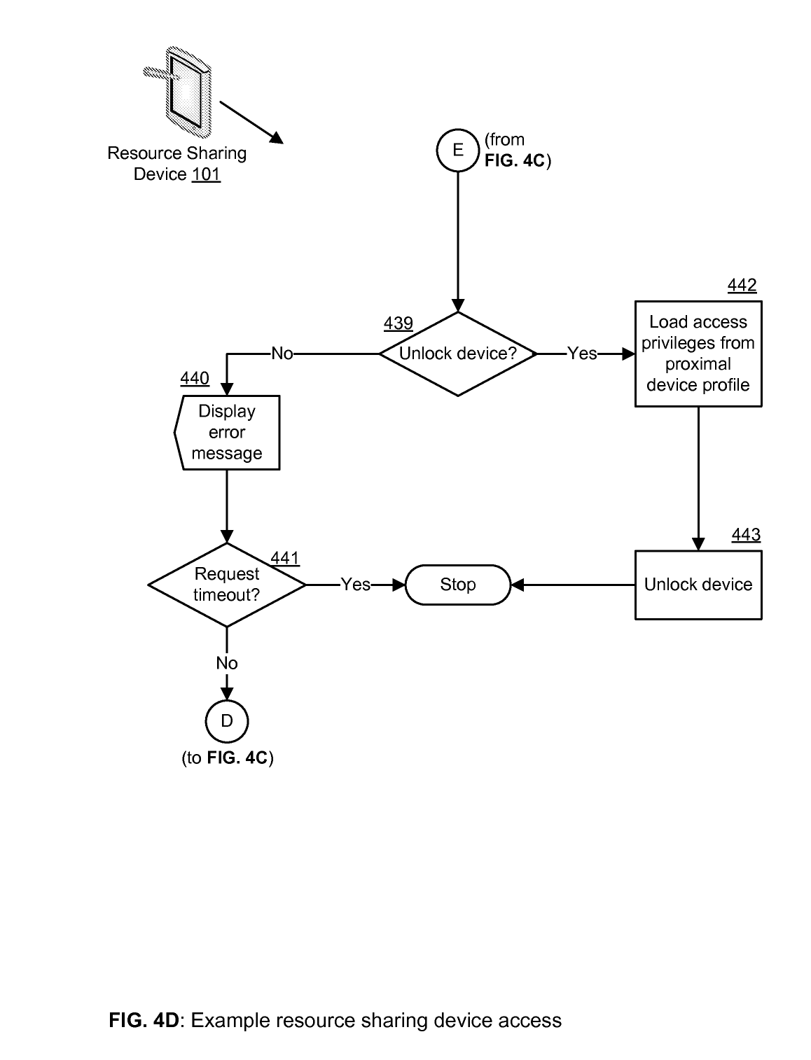

If the resource sharing device user is authenticated (step 312; YES), the resource sharing device 101 may obtain proximal device data from the proximal device for which an access privilege profile in the resource sharing device's access privilege profile database is to be created and/or updated (step 316). The resource sharing device 101 may generate a set of random authentication keys (e.g., 128-bit encryption keys) (step 317). Using the obtained proximal device data from the proximal device, the randomly generated keys, and optionally input from the resource sharing device user 103, the resource sharing device 101 may generate or update the proximal device access privilege profile (step 318). The resource sharing device 101 may provide a public encryption key (e.g., for proximal device 102a to engage in RSA or other encryption-based communication with the resource sharing device 101) and the set of randomly-generated authentication keys for the proximal device 102a (step 319). The public encryption key may be to ensure the data exchanges are encrypted, and pool of random keys to ensure secure communication on unsecured networks, as explained further below in the description with reference to FIGS. 4A-D. The set of randomly-generated authentication keys may be maintained along with the proximal device access privilege profile until the proximal device 102a is unpaired from the resource sharing device 101 (e.g., by deletion of the proximal device access privilege profile associated with the proximal device 102a from the proximal device access privilege profile database of the resource sharing device 101). The resource sharing device 101 may add the proximal device ID associated with the newly “paired” proximal device 102a to a list of found proximal devices (step 320). The resource sharing device 101 may repeat the procedures described above for any additional proximal devices for which proximal device access privilege profile are required to be created or updated (see, e.g., FIG. 2, 218).

FIGS. 4A-D are flow diagrams illustrating an example resource sharing device access procedure consistent with some embodiments of the present disclosure. With reference to FIG. 4A, in some embodiments, a user may provide an input into a resource sharing device 101 to unlock the resource sharing device 101 (step 411). The resource sharing device 101 may display an options UI, e.g., allowing the user to choose between a traditional mechanism to unlock the resource sharing device 101 or a paired unlock mechanism (step 412). The user may provide an input into resource sharing device 101 to select one of the unlock mechanisms (step 413).

If the user selects a traditional unlock mechanism (step 414; NO), the resource sharing device 101 may display a resource sharing device unlock UI (step 415). The user may provide a user unlock input associated with the user profile linked to the resource sharing device 101 (step 416). If the user unlock input properly unlocks the resource sharing device 101 (step 417; YES), the resource sharing device 101 may load a default resource sharing device user profile (step 419) and unlock the resource sharing device 101 for the user (step 420). If the user unlock input does not properly unlock the resource sharing device 101 (step 417; NO), the resource sharing device 101 may display an error message for the user via an electronic display operably coupled to the resource sharing device 101 (step 418). The resource sharing device 101 may return the procedure either to displaying the options UI (see step 412) or the resource sharing device unlock UI (see step 415). For example, the resource sharing device 101 may return the procedure to step 415 for a predetermined number of failed unlock attempts (e.g., three), and thereafter return the procedure to step 412.

With reference to FIG. 4B, if the user selects a paired unlock mechanism (step 414; YES), the resource sharing device 101 may generate and display a proximal device list at step 421 (see, e.g., FIG. 2). The user may enter a user selection of a proximal device presented in the proximal device list (step 422). Using the user selection of the proximal device, the resource sharing device 101 may access its proximal device access privilege profile database, and retrieve the proximal device profile corresponding to the user-selected proximal device from the proximal device list (step 423). For example, the resource sharing device 101 may utilize Structured Query Language (SQL) commands within a Hypertext Preprocessor (PHP) script to query a relational database management system (RDBMS) using the proximal device ID as a query/lookup input variable to retrieve the proximal device profile. The resource sharing device 101 may parse the retrieved proximal device profile, and determine whether user security input format UI data for the proximal device is available in the proximal device profile (step 424). If the user security input format UI data for the proximal device is available in the proximal device profile (step 424; YES), the resource sharing device 101 may proceed directly to the exemplary procedure of FIG. 3C. If the user security input format UI data for the proximal device is not available in the proximal device profile (step 424; NO), the resource sharing device 101 may communicate with the proximal device, and request the proximal device for proximal device security input format data, such that the resource sharing device 101 can, using the received data from proximal device 102a, recreate the proximal device user security input UI 105 of the proximal device 102a via the electronic display operably coupled to the resource sharing device 101 (step 425). In some embodiments, the resource sharing device 101 may also request the proximal device to provide, as an authentication key, one of the randomly-generated keys selected from the set of randomly-generated keys the resource sharing device 101 provided to the proximal device during the creation/update of the proximal device access privilege profile associated with the proximal device (see, e.g., FIG. 3, step 319). For example, the resource sharing device 101 may request key number k, 1≦k≦N, where N is the total number of randomly-generated authentication keys that the resource sharing device 101 provided to the proximal device during the creation/update of the proximal device access privilege profile associated with that proximal device.

In response, the proximal device may provide the requested proximal device security input format data and authentication key to the resource sharing device 101 (step 426). The resource sharing device 101 may compare the obtained authentication key from the proximal device to the specific previously-provided, randomly-generated authentication key of the same number, as stored in the proximal device access privilege profile (step 427). If the keys do not match (step 428; NO), the resource sharing device 101 may provide an error notification to the proximal device (step 429), and if there is no request timeout (e.g., too many attempts), see step 430; NO, the resource sharing device 101 may return to step 425 and repeat the request for proximal device security input format data. If there is a request timeout, e.g., too many failed authentication attempts by the proximal device, the procedure may terminate, see step 430; YES.

With reference to FIG. 4C, if the keys do match (step 428; YES), and the proximal device user security input format data is authenticated, the resource sharing device 101 may generate and display the proximal device user security input UI on the electronic display operably coupled to the resource sharing device 101 (step 431). Now, the user may provide a security input into the resource sharing device 101 that, normally, the user would enter into proximal device (step 432). The resource sharing device 101 may communicate any user security input (e.g., password, finger swipe, voice authentication, biometric authentication, etc.) provided by the user to the proximal device for user authentication (step 433).

The proximal device 102a may determine whether the user security input is authenticated (step 434). If the user is authenticated (step 435; YES), the proximal device 102a may select an acknowledge key from the randomly-generated set of authentication keys previously provided to the proximal device 102a by the resource sharing device 101 (step 437). If the user is not authenticated (step 435; NO), the proximal device 102a may select an error key from the randomly-generated set of authentication keys previously provided to the proximal device 102a by the resource sharing device 101 (step 436). The proximal device 102a may return the selected key to the resource sharing device 101 (step 438).

With reference to FIG. 4D, the resource sharing device 101 may determine whether the key returned by the proximal device is an error key or an acknowledge key (step 439). If the key returned is an error key (step 439; NO), the resource sharing device 101 may display an error message via the electronic display operably coupled to it (step 440). If a number of paired unlock mechanism attempts exceeds a threshold, a request timeout may be considered to have taken place (see, e.g., step 441; YES), and the resource sharing device 101 may terminate the procedure. Otherwise (step 441; NO), the resource sharing device 101 may return the procedure to displaying the proximal device user security input UI on the electronic display operably coupled to it (see FIG. 4C, step 431).

If the key returned is an acknowledge key (step 439; YES), the resource sharing device 101 may load the access privileges associated with the proximal device (and/or the proximal device user) from the appropriate proximal device profile (step 442). The resource sharing device may also unlock itself to provide access to the user (step 443).

Additional illustrative embodiments are listed below. In one embodiment, an access privilege control apparatus is disclosed, comprising: a processor; and a memory storing processor-executable instructions comprising instructions for: obtaining a proximal device identifier associated with a proximal device; determining one or more access privileges associated with the proximal device; generating access privilege data related to the one or more access privileges; generating a proximal device profile including the proximal device identifier and the access privilege data; and storing the proximal device profile. The apparatus may be, for example, a mobile device, set-top box, television, computer, or other user-interfacing device. The proximal device may be, for example, a mobile device, set-top box, television, computer, or other user-interfacing device. Access privileges may include at least one of: a data access privilege; a user profile access privilege; an application access privilege; an operating system access privilege; and/or a hardware access privilege. The proximal device identifier may be one of: a media access control (MAC) address; a computer network address; an Internet Protocol (IP) address; or any other identifier capable of uniquely identifying a device or user of a device. The access privilege data may be generated in a human-readable data format. Generating the proximal device profile may comprise: identifying a pre-existing device profile associated with the proximal device; and updating the pre-existing device profile to include the proximal device identifier and the access privilege data. The proximal device profile may be stored in a memory device included in or remote from the apparatus. The instructions may further comprise instructions for: storing a plurality of proximal device profiles related to the proximal device; wherein each of the plurality of proximal device profiles is associated with a different user account on the proximal device. The instructions may further comprise instructions for: providing, for the proximal device, a plurality of randomly-generated authentication keys associated with the proximal device profile; and storing the randomly-generated authentication keys. The instructions may further comprise instructions for providing a public encryption key for communication between the proximal device and the apparatus.

In one embodiment, an access privilege control method is disclosed, comprising: obtaining a proximal device identifier associated with a proximal device; determining one or more access privileges associated with the proximal device; generating access privilege data related to the one or more access privileges; generating a proximal device profile including the proximal device identifier and the access privilege data; and storing the proximal device profile. The apparatus performing the method may be, for example, a mobile device, set-top box, television; computer, or other user-interfacing device. The proximal device may be, for example, a mobile device, set-top box, television, computer, or other user-interfacing device. One or more access privileges may include at least one of: a data access privilege; a user profile access privilege; an application access privilege; an operating system access privilege; and/or a hardware access privilege. The proximal device identifier may be one of: a media access control (MAC) address; a computer network address; an Internet Protocol (IP) address; or any other identifier capable of uniquely identifying a device or user of a device. The access privilege data may be generated in a human-readable data format. Generating the proximal device profile may comprise: identifying a pre-existing device profile associated with the proximal device; and updating the pre-existing device profile to include the proximal device identifier and the access privilege data. The proximal device profile may be stored in a memory device included in or remote from the apparatus. The method may further comprise: storing a plurality of proximal device profiles related to the proximal device; wherein each of the plurality of proximal device profiles is associated with a different user account on the proximal device. The method may further comprise: providing, for the proximal device, a plurality of randomly-generated authentication keys associated with the proximal device profile; and storing the randomly-generated authentication keys. The method may further comprise: providing a public encryption key for communication between the proximal device and the apparatus.

In one embodiment, a non-transitory computer-readable medium is disclosed, storing computer-executable access privilege control instructions, the instructions comprising instructions for: obtaining a proximal device identifier associated with a proximal device; determining one or more access privileges associated with the proximal device; generating access privilege data related to the one or more access privileges; generating a proximal device profile including the proximal device identifier and the access privilege data; and storing the proximal device profile. The medium may be embodied in, for example, a mobile device, set-top box, television, computer, or other user-interfacing device. The proximal device may be, for example, a mobile device, set-top box, television, computer, or other user-interfacing device. One or more access privileges may include at least one of: a data access privilege; a user profile access privilege; an application access privilege; an operating system access privilege; and/or a hardware access privilege. The proximal device identifier may be one of: a media access control (MAC) address; a computer network address; and an Internet Protocol (IP) address; or any other identifier capable of uniquely identifying a computing device or user of a device. The access privilege data may be generated in a human-readable data format. Generating the proximal device profile may comprise: identifying a pre-existing device profile associated with the proximal device; and updating the pre-existing device profile to include the proximal device identifier and the access privilege data. The proximal device profile may be stored in a memory device included in or remote from the apparatus. The instructions may further comprise instructions for: storing a plurality of proximal device profiles related to the proximal device; wherein each of the plurality of proximal device profiles is associated with a different user account on the proximal device. The instructions may further comprise instructions for: providing, for the proximal device, a plurality of randomly-generated authentication keys associated with the proximal device profile; and storing the randomly-generated authentication keys. The instructions may further comprise instructions for: providing a public encryption key for communication between the proximal device and the apparatus.

### Computer System

FIG. 5 is a block diagram of an exemplary computer system for implementing embodiments consistent with the present disclosure. Variations of computer system 501 may be used for implementing resource sharing device 101 and proximal device 102a. Computer system 501 may comprise a central processing unit (“CPU” or “processor”) 502. Processor 502 may comprise at least one data processor for executing program components for executing user- or system-generated requests. The processor may include specialized processing units such as integrated system (bus) controllers, memory management control units, floating point units, graphics processing units, digital signal processing units, etc. The processor may include a microprocessor, such as AMD Athlon, Duron or Opteron, ARM's application, embedded or secure processors, IBM PowerPC, Intel's Core, Itanium, Xeon, Celeron or other line of processors, etc. The processor 502 may be implemented using mainframe, distributed processor, multi-core, parallel, grid, or other architectures. Some embodiments may utilize embedded technologies like application-specific integrated circuits (ASICs), digital signal processors (DSPs), Field Programmable Gate Arrays (FPGAs), etc.

Processor 502 may be disposed in communication with one or more input/output (I/O) devices via I/O interface 503. The I/O interface 503 may employ communication protocols/methods such as, without limitation, audio, analog, digital, monoaural, RCA, stereo, IEEE-1394, serial bus, universal serial bus (USB), infrared, PS/2, BNC, coaxial, component, composite, digital visual interface (DVI), high-definition multimedia interface (HDMI), RF antennas, S-Video, VGA, IEEE 802.n/b/g/n/x, Bluetooth, cellular (e.g., code-division multiple access (CDMA), high-speed packet access (HSPA+), global system for mobile communications (GSM), long-term evolution (LTE), WiMax, or the like), etc.

Using the I/O interface 503, the computer system 501 may communicate with one or more I/O devices. For example, the input device 504 may be an antenna, keyboard, mouse, joystick, (infrared) remote control, camera, card reader, fax machine, dongle, biometric reader, microphone, touch screen, touchpad, trackball, sensor (e.g., accelerometer, light sensor, GPS, gyroscope, proximity sensor, or the like), stylus, scanner, storage device, transceiver, video device/source, visors, etc. Output device 505 may be a printer, fax machine, video display (e.g., cathode ray tube (CRT), liquid crystal display (LCD), light-emitting diode (LED), plasma, or the like), audio speaker, etc. In some embodiments, a transceiver 506 may be disposed in connection with the processor 502. The transceiver may facilitate various types of wireless transmission or reception. For example, the transceiver may include an antenna operatively connected to a transceiver chip (e.g., Texas Instruments WiLink WL1283, Broadcom BCM4750IUB8, Infineon Technologies X-Gold 618-PMB9800, or the like), providing IEEE 802.11a/b/g/n, Bluetooth, FM, global positioning system (GPS), 2G/3G HSDPA/HSUPA communications, etc.

In some embodiments, the processor 502 may be disposed in communication with a communication network 508 via a network interface 507. The network interface 507 may communicate with the communication network 508. The network interface may employ connection protocols including, without limitation, direct connect, Ethernet (e.g., twisted pair 10/100/1000 Base T), transmission control protocol/internet protocol (TCP/IP), token ring, IEEE 802.11a/b/g/n/x, etc. The communication network 508 may include, without limitation, a direct interconnection, local area network (LAN), wide area network (WAN), wireless network (e.g., using Wireless Application Protocol), the Internet, etc. Using the network interface 507 and the communication network 508, the computer system 501 may communicate with devices 509, 510, and 511. These devices may include, without limitation, personal computer(s), server(s), fax machines, printers, scanners, various mobile devices such as cellular telephones, smartphones (e.g., Apple iPhone, Blackberry, Android-based phones, etc.), tablet computers, eBook readers (Amazon Kindle, Nook, etc.), laptop computers, notebooks, gaming consoles (Microsoft Xbox, Nintendo DS, Sony PlayStation, etc.), or the like. In some embodiments, the computer system 501 may itself embody one or more of these devices.

In some embodiments, the processor 502 may be disposed in communication with one or more memory devices (e.g., RAM 513, ROM 514, etc.) via a storage interface 512. The storage interface may connect to memory devices including, without limitation, memory drives, removable disc drives, etc., employing connection protocols such as serial advanced technology attachment (SATA), integrated drive electronics (IDE), IEEE-1394, universal serial bus (USB), fiber channel, small computer systems interface (SCSI), etc. The memory drives may further include a drum, magnetic disc drive, magneto-optical drive, optical drive, redundant array of independent discs (RAID), solid-state memory devices, solid-state drives, etc.

The memory devices may store a collection of program or database components, including, without limitation, an operating system 516, user interface application 517, web browser 518, mail server 519, mail client 520, user/application data 521 (e.g., any data variables or data records discussed in this disclosure), etc. The operating system 516 may facilitate resource management and operation of the computer system 501. Examples of operating systems include, without limitation, Apple Macintosh OS X, Unix, Unix-like system distributions (e.g., Berkeley Software Distribution (BSD), FreeBSD, NetBSD, OpenBSD, etc.), Linux distributions (e.g., Red Hat, Ubuntu, Kubuntu, etc.), IBM OS/2, Microsoft Windows (XP, Vista/7/8, etc.), Apple iOS, Google Android, Blackberry OS, or the like. User interface 517 may facilitate display, execution, interaction, manipulation, or operation of program components through textual or graphical facilities. For example, user interfaces may provide computer interaction interface elements on a display system operatively connected to the computer system 501, such as cursors, icons, check boxes, menus, scrollers, windows, widgets, etc. Graphical user interfaces (GUIs) may be employed, including, without limitation, Apple Macintosh operating systems' Aqua, IBM OS/2, Microsoft Windows (e.g., Aero, Metro, etc.), Unix X-Windows, web interface libraries (e.g., ActiveX, Java, Javascript, AJAX, HTML, Adobe Flash, etc.), or the like.

In some embodiments, the computer system 501 may implement a web browser 518 stored program component. The web browser may be a hypertext viewing application, such as Microsoft Internet Explorer, Google Chrome, Mozilla Firefox, Apple Safari, etc. Secure web browsing may be provided using HTTPS (secure hypertext transport protocol), secure sockets layer (SSL), Transport Layer Security (TLS), etc. Web browsers may utilize facilities such as AJAX, DHTML, Adobe Flash, JavaScript, Java, application programming interfaces (APIs), etc. In some embodiments, the computer system 501 may implement a mail server 519 stored program component. The mail server may be an Internet mail server such as Microsoft Exchange, or the like. The mail server may utilize facilities such as ASP, ActiveX, ANSI C++/C#, Microsoft .NET, CGI scripts, Java, JavaScript, PERL, PHP, Python, WebObjects, etc. The mail server may utilize communication protocols such as internet message access protocol (IMAP), messaging application programming interface (MAPI), Microsoft Exchange, post office protocol (POP), simple mail transfer protocol (SMTP), or the like. In some embodiments, the computer system 501 may implement a mail client 520 stored program component. The mail client may be a mail viewing application, such as Apple Mail, Microsoft Entourage, Microsoft Outlook, Mozilla Thunderbird, etc.

In some embodiments, computer system 501 may store user/application data 521, such as the data, variables, records, etc. (e.g., a proximal device access privilege profile database (see, e.g., Table I above), proximal device list (see, e.g., FIG. 2, element 219; FIG. 3, step 320), user security input format data (see, e.g., FIG. 4B, step 425), failed attempts counter threshold (see, e.g., FIG. 3, step 314), random authentication keys (see, e.g., FIG. 3, step 317), public encryption keys (see, e.g., FIG. 3, step 319), option UI data (see FIG. 4A, step 412), resource sharing device unlock UI data (see FIG. 4A, step 415), user unlock/security input (see, e.g., FIG. 4A, step 416; FIG. 4C, step 432), etc.) as described in this disclosure. Such databases may be implemented as fault-tolerant, relational, scalable, secure databases such as Oracle or Sybase. Alternatively, such databases may be implemented using standardized data structures, such as an array, hash, linked list, struct, structured text file (e.g., XML), table, or as object-oriented databases (e.g., using ObjectStore, Poet, Zope, etc.). Such databases may be consolidated or distributed, sometimes among the various computer systems discussed above in this disclosure. It is to be understood that the structure and operation of the any computer or database component may be combined, consolidated, or distributed in any working combination.

The specification has described systems and methods for accessing a device using a paired device in its proximity. The illustrated steps are set out to explain the exemplary embodiments shown, and it should be anticipated that ongoing technological development will change the manner in which particular functions are performed. These examples are presented herein for purposes of illustration, and not limitation. Further, the boundaries of the functional building blocks have been arbitrarily defined herein for the convenience of the description. Alternative boundaries can be defined so long as the specified functions and relationships thereof are appropriately performed. Alternatives (including equivalents, extensions, variations, deviations, etc., of those described herein) will be apparent to persons skilled in the relevant art(s) based on the teachings contained herein. Such alternatives fall within the scope and spirit of the disclosed embodiments.

Furthermore, one or more computer-readable storage media may be utilized in implementing embodiments consistent with the present disclosure. A computer-readable storage medium refers to any type of physical memory on which information or data readable by a processor may be stored. Thus, a computer-readable storage medium may store instructions for execution by one or more processors, including instructions for causing the processor(s) to perform steps or stages consistent with the embodiments described herein. The term “computer-readable medium” should be understood to include tangible items and exclude carrier waves and transient signals, i.e., be non-transitory. Examples include random access memory (RAM), read-only memory (ROM), volatile memory, nonvolatile memory, hard drives, CD ROMs, DVDs, flash drives, disks, and any other known physical storage media.

It is intended that the disclosure and examples be considered as exemplary only, with a true scope and spirit of disclosed embodiments being indicated by the following claims.

What is claimed is:

1. A resource sharing apparatus, comprising:
a processor; and
a memory storing processor-executable instructions comprising instructions for:
obtaining a proximal device identifier associated with a proximal device;
identifying a proximal device profile associated with the proximal device identifier;
retrieving access privilege data stored in the proximal device profile;
generating user interface data based on the access privilege data; and
providing the user interface data for display.

2. The apparatus of claim 1, the instructions further comprising instructions for:
providing, for the proximal device, an authentication key identifier and a request for user security input format data;
obtaining, from the proximal device:
an authentication key associated with the authentication key identifier, and
user security input format data;
determining that the proximal device is authenticated, based on the authentication key; and
displaying a user security input interface based on the user security input format data.

3. The apparatus of claim 2, the instructions further comprising instructions for:
obtaining a user security input via the user security input interface;
providing, for the proximal device:
the user security input, and
a second authentication key identifier;
obtaining, from the proximal device, a second authentication key associated with the second authentication key identifier; and
determining that the user security input is valid, based on the second authentication key;
wherein providing the user interface data for display is performed after determining that the user security input is valid.

4. The apparatus of claim 1, wherein the user interface data is provided for display on a display device operatively connected to the resource sharing apparatus.

5. The apparatus of claim 1, wherein the apparatus is one of: a mobile device; a set-top box; a television; or a computer.

6. The apparatus of claim 1, wherein the proximal device is one of: a mobile device; a set-top box; a television; or a computer.

7. The apparatus of claim 1, wherein the proximal device identifier is one of: a media access control (MAC) address; a computer network address; or an Internet Protocol (IP) address.

8. The apparatus of claim 1, wherein the access privilege data includes data relating to at least one of: a data access privilege; a user profile access privilege; an application access privilege; an operating system access privilege; or a hardware access privilege.

9. The apparatus of claim 8, wherein the user interface data includes data relating to an application accessible under the application access privilege.

10. The apparatus of claim 8, wherein the user interface data includes data relating to a data file accessible under the data access privilege.

11. The apparatus of claim 8, wherein the user interface data includes data relating to a hardware component accessible under the hardware access privilege.

12. The apparatus of claim 11, wherein the hardware component is one of: a communication device; an encryption device; a storage device; or a communication port.

13. A resource sharing method, comprising:
obtaining a proximal device identifier associated with a proximal device;
identifying a proximal device profile associated with the proximal device identifier;
retrieving access privilege data stored in the proximal device profile;
generating, via a processor, user interface data based on the access privilege data; and
providing the user interface data for display.

14. The method of claim 13, further comprising:
providing, for the proximal device, an authentication key identifier and a request for user security input format data;
obtaining, from the proximal device:
an authentication key associated with the authentication key identifier, and
user security input format data;
determining that the proximal device is authenticated, based on the authentication key; and
displaying a user security input interface based on the user security input format data.

15. The method of claim 14, further comprising:
obtaining a user security input via the user security input interface;
providing, for the proximal device:
the user security input, and
a second authentication key identifier;
obtaining, from the proximal device, a second authentication key associated with the second authentication key identifier; and
determining that the user security input is valid, based on the second authentication key;
wherein providing the user interface data for display is performed after determining that the user security input is valid.

16. The method of claim 13, wherein the user interface data is provided for display on a display device operatively connected to the resource sharing apparatus.

17. The method of claim 13, wherein the apparatus is one of: a mobile device; a set-top box; a television; or a computer.

18. The method of claim 13, wherein the proximal device is one of: a mobile device; a set-top box; a television; or a computer.

19. The method of claim 13, wherein the proximal device identifier is one of: a media access control (MAC) address; a computer network address; or an Internet Protocol (IP) address.

20. The method of claim 13, wherein the access privilege data includes data relating to at least one of: a data access privilege; a user profile access privilege; an application access privilege; an operating system access privilege; or a hardware access privilege.

21. The method of claim 20, wherein the user interface data includes data relating to an application accessible under the application access privilege.

22. The method of claim 20, wherein the user interface data includes data relating to a data file accessible under the data access privilege.

23. The method of claim 20, wherein the user interface data includes data relating to a hardware component accessible under the hardware access privilege.

24. The method of claim 23, wherein the hardware component is one of: a communication device; an encryption device; a storage device; or a communication port.

25. A non-transitory computer-readable medium storing computer-executable resource sharing instructions, the instructions comprising instructions for:
obtaining a proximal device identifier associated with a proximal device;
identifying a proximal device profile associated with the proximal device identifier;
retrieving access privilege data stored in the proximal device profile;
generating user interface data based on the access privilege data; and
providing the user interface data for display.
